(19) United States
(12) Patent Application Publication
(10) Pub. No.: US 2016/0335965 A1
(43) Pub. Date: Nov. 17, 2016

(54) DISPLAY DIODE RELATIVE AGE TRACKING

(71) Applicant: Microsoft Technology Licensing, LLC, Redmond, WA (US)

(72) Inventors: Jiandong HUANG, Bellevue, WA (US); Ying ZHENG, Redmond, WA (US); Steven BATHICHE, Kirkland, WA (US); Rajesh DIGHDE, Redmond, WA (US)

(73) Assignee: Microsoft Technology Licensing, LLC, Redmond, WA (US)

(21) Appl. No.: 14/711,689

(22) Filed: May 13, 2015

(51) Int. Cl. G09G 3/36; G09G 3/32

(52) U.S. Cl. CPC G09G 3/3611; G09G 3/3208; G09G 2320/043; G09G 2320/0626

(57) ABSTRACT

The description relates to display device image quality. One example can include a display, a processor, storage, and a pixel run time counter. The display can include a set of multiple pixels. Individual pixels can include multiple color light emitting diodes (LEDs). The processor can be configured to convert image related data into frame renderings for driving the multiple pixels of the display and the storage can be accessible by the processor. The pixel run time counter can be configured to store pixel information for a subset of individual pixels relative to individual frame renderings on the storage. The stored pixel information from multiple subsets of individual pixels of the frame renderings can collectively reflect time and intensity parameters that the frame renderings have driven the set of pixels.

### BRIEF DESCRIPTION OF THE DRAWINGS

The accompanying drawings illustrate implementations of the concepts conveyed in the present document. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the FIG. and associated discussion where the reference number is first introduced.

FIG. 1 shows a display diode use case scenario example in accordance with some implementations of the present concepts.

FIG. 2 shows a system example in accordance with some implementations of the present concepts.

FIGS. 3, 4, 7, and 8 show visual content processing pipeline examples in accordance with some implementations of the present concepts.

FIGS. 5 and 6 show pixel selection scenario examples in accordance with some implementations of the present concepts.

FIG. 9 shows an example flowchart in accordance with some implementations of the present concepts.

### DESCRIPTION

Current light emitting diode (LED) displays can suffer from image degradation due to operational aging (e.g., performance degradation) of the light emitting materials (e.g., irreversible decrease of luminance with operation time) and/or screen burn in (e.g., different intensity of image across pixels). Moreover, different colors of LEDs, such as red, green, and blue emitting materials have different aging speeds. The present implementations can track this degradation and compensate for the degradation to reduce performance loss of the display as it ages from use (e.g., performance degrades). The compensation can address multiple performance aspects, such as pixel to pixel illumination intensity and/or pixel image quality parameters, such as pixel color.

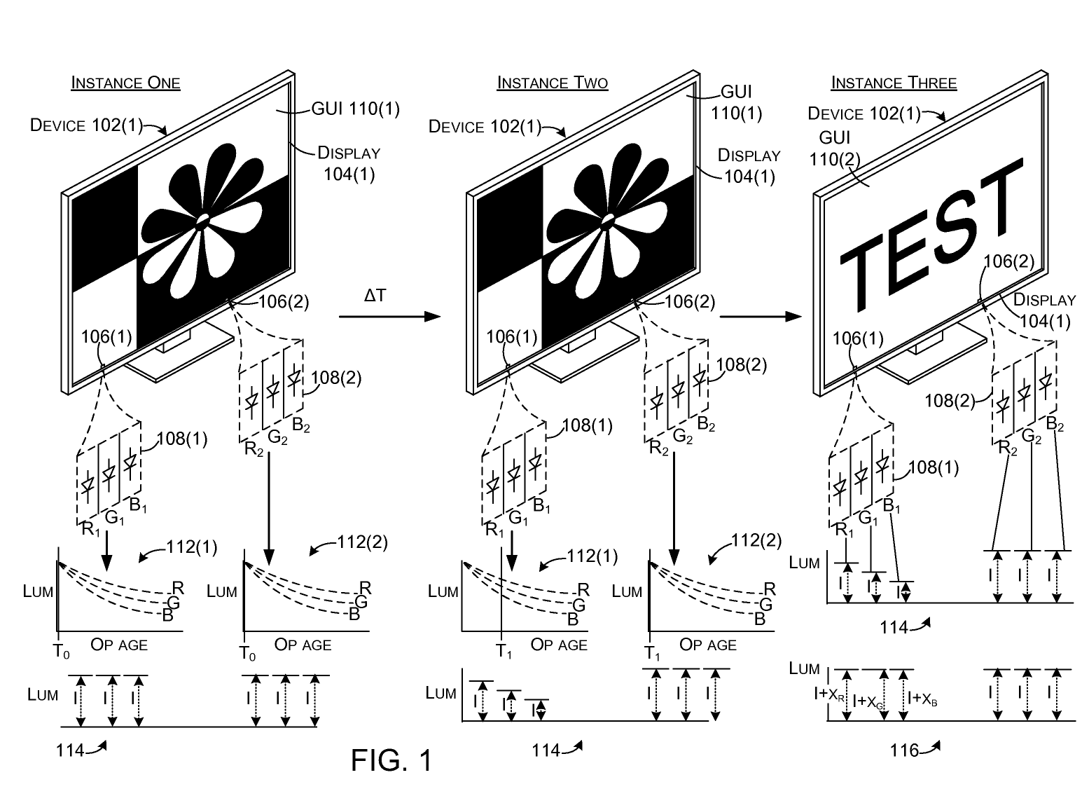

FIG. 1 shows a device 102(1) and illustrates an introductory display diode operational age example relative to device 102(1). The device can include a display or screen 104(1). The display can include multiple pixels 106. For sake of brevity only two pixels 106(1) and 106(2) are designated with specificity. Individual pixels can include one or more independently controllable light emitting diodes (LEDs) 108, such as organic light emitting diodes (OLED), inorganic light emitting diodes, and/or other controllable devices or materials, such as quantum dot materials. Individual pixels may also be implemented using a liquid crystal display (LCD), a color filter, and a backlight (in which the backlight itself may be comprised of one or more LEDs). In an LCD, it is possible that the LEDs in the backlight or the LCD pixels themselves may degrade or otherwise suffer from defects or distortion. In the example of FIG. 1, each pixel 106 includes a red (R) LED, a green (G) LED, and a blue (B) LED. For purposes of explanation, FIG. 1 shows device 102(1) at Instance One, Instance Two, and Instance Three.

Starting at Instance One, assume for purposes of explanation that the device 102(1) is essentially new (e.g., operational time T₀). At this point, a GUI 110(1) is presented on the display 104(1). Also shown at Instance One is a performance degradation graph 112 for each pixel. The performance degradation graph charts diode luminosity over operational age for each color LED (e.g., R, G, and B) of the pixels of the display 104(1). Performance (e.g., luminosity) decreases with operational age. Also, degradation graphs 112(1) and 112(2) are equal (and can be equal for all of the pixels of the device). Separate degradation graphs are shown for each pixel to show that individual pixels can experience different operational environments during the lifetime of the display 104(1). At this point, all of the LEDs of pixel 106(1) are performing ‘as new’ at time T₀ (since they are in fact new) on degradation graph 112(1). Similarly, all of the LEDs of pixel 106(2) are performing as new at time T₀ on degradation graph 112(2). Thus, as shown by luminosity graph 114, when driven at an equivalent intensity ‘I’, R₁, G₁, B₁, R₂, G₂, and B₂ would deliver the expected (and equal) luminosity (LUM). However, on GUI 110(1) of Instance One, pixel 106(1) is in a white-colored region of the GUI and pixel 106(2) is in a black-colored region. White color is generated at Instance One by driving R₁, G₁, and B₁ at equal intensities, such as 80% for example. In contrast, the black color is generated at Instance One by leaving R₂, G₂, and B₂ turned off (e.g., driving them at zero intensity). Now assume that the state of Instance One is continued for a duration of time (ΔT), such as 100 hours, until Instance Two.

At Instance Two, the GUI 110(1) has been displayed for 100 hours. At this point, as can be evidenced by comparing degradation graph 112(1) and 112(2), the operational age or effective age (represented by T₁) of the LEDs of pixel 106(1) are now different than the operational age (T₁) of the LEDs of pixel 106(2). For example, compare T₁ of degradation graph 112(1) to T₁ of degradation graph 112(2). Essentially, the R, G, and B LEDs 108(2) of pixel 106(2) are ‘new’ since they have not been powered (e.g., driven). In contrast, the R, G, and B LEDs 108(1) of pixel 106(1) have aged (e.g., T₁ on degradation graph 112(1) has shifted to the right). At this point, from an operational perspective, the LEDs 108(1) of pixel 106(1) are older than the LEDs 108(2) of pixel 106(2) and as such do not perform the same as the LEDs of pixel 106(2) or as they (e.g., LEDs 108(1)) did when they were ‘new’. Further, because the degradation curves of red LEDs, green LEDs, and blue LEDs are different, the operational age of the red, green, and blue LEDs of pixel 106(1) are different from one another. This can be evidenced from the luminosity graph 114 of Instance Two. Recall that each LED is driven at the same intensity I. However, the resultant luminosities (vertical axis) of the LEDs of pixel 106(1) are less than those of the LEDs of pixel 106(2). Further, the blue LED of pixel 106(1) has the lowest luminosity, the green LED has the intermediate luminosity and the red LED the highest luminosity (though still lower than all of the LEDs of pixel 106(2)). Assume that at this point GUI 110(1) is changed to GUI 110(2) of Instance Three.

Instance Three shows GUI 110(2) presented on display 104(1). On GUI 110(2) both pixel 106(1) and pixel 106(2) are white. Assume further that both pixels are intended to be the same ‘color’ white (e.g., identical colors) and the same intensity as one another. Recall however from the discussion of Instance Two that the LEDs 108 of these two pixels are no longer the same operational or effective age. The luminosity graph 114 from Instance Two is reproduced at Instance Three to illustrate this point. If driven at equivalent intensities, the luminosity of LEDs 108(1) vary among themselves and are lower than the luminosity of LEDs 108(2). This would produce two visual problems. First, pixel 106(1) would appear dimmer (e.g. less luminous) than pixel 106(2) on the GUI 110(2).

Second, recall that the specific color of white desired is accomplished by an individual pixel 106 by equal luminosity from its red, green, and blue LEDS 108. However, in this case, the blue LED 108(1) is less luminous than the green LED 108(1), which is less luminous than the red LED 108(1). As such, the ‘color’ produced by pixel 106(1) will be different than the ‘color’ produced by pixel 106(2). For instance, pixel 106(1) might appear as ‘off white’ because the red, green, and blue LEDs contribute unequally to produce white, while pixel 106(2) appears as a ‘true white’ because the red, green, and blue LEDs contribute equally to produce white. To address these issues, device 102(1) can adjust the intensity I that it drives the LEDs 108(1) of pixel 106(1) to create more uniformity of luminance and color between pixel 106(1) and 106(2). For example, assume that intensity I is 80%. The LEDs 108(2) of pixel 106(2) can be driven at 80% intensity. The LEDs 108(1) of pixel 106(1) can be driven at an intensity that is greater than I, such as I+X to get back to the luminance produced by LEDs 108(2) at 80% at Instance 1. Further, the ‘X’ value can be customized for each LED 108(1) to reflect its degradation curve. For example, the X value for the blue LED (e.g., (X_{B})) can be the largest since it has suffered the most performance degradation. The X value for the green pixel 108(1) (e.g., (X_{G})) can be slightly less, and the X value for the red pixel (e.g., (X_{R})) can be even less. For instance, X_{B} could equal 14%, X_{G} could equal 12%, and X_{R} could equal 10%. As such, by driving LEDs 108(2) at 80% and red LED 108(1) at 90%, green LED 108(1) at 92%, and blue LED 108(1) at 94%, the display can simulate the ‘new’ condition where all of the LEDs 108(1) and 108(2) would be driven at 80% to achieve the same color and luminosity. This is a somewhat simplified example in that by using ‘white’ and ‘black’ the operational age of the LEDs of an individual pixel remain relatively close. However, if the GUI 110(1) in Instance One was blue and black for example, rather than white and black, and GUI 110(2) of Instance Three was white, then the blue LED 108(1) of pixel 106(1) would be aging at Instances One and Two, while the red and green LEDs 108(1) of pixel 106(1) would not. Such a scenario can be addressed in a similar manner to compensate for intra pixel LED degradation and inter pixel LED degradation.

In still another example, the intensity of the aging LEDs may not be able to be increased to correct to original luminosity. For instance, in the above described example, the frame rendering drove the LEDs at 80% at Instance Three so the intensity of LEDs 108(1) could be increased, such as to 90%, 92% and 94%. However, if GUI 110(2) is driving the pixels at 100% intensity, then the values cannot be adjusted higher. In such a case, various techniques can be applied. In one case, all of the intensities could be lowered, such as to 75%, then the LEDs of pixel 106(1) (e.g., the aging pixels) can be adjusted upward. Such a configuration can maintain a relative appearance of the pixels (e.g., pixel 106(1) looks the same as pixel 106(2) but at a lower (e.g., dimmed) intensity than specified in the frame rendering for GUI 110(2)).

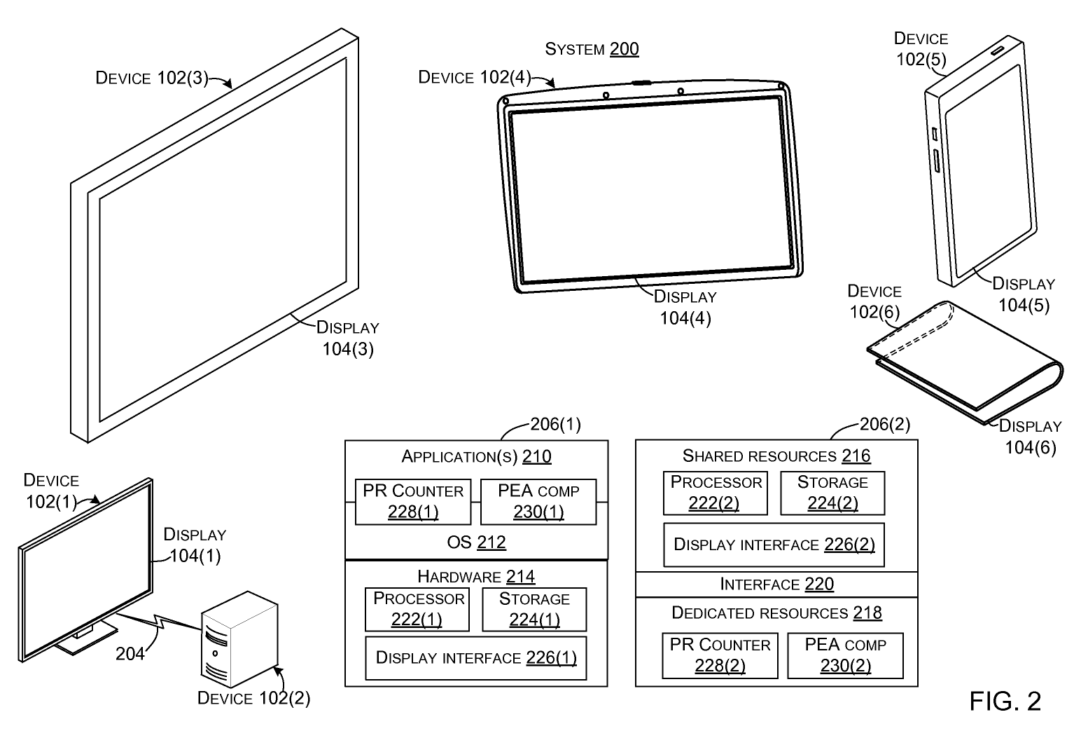

FIG. 2 illustrates an example system 200 that shows various device implementations. In this case, six device implementations are illustrated. Device 102(1) can operate cooperatively with device 102(2) that is manifest as a personal computer or entertainment console. Device 102(3) is manifest as a television, device 102(4) is manifest as a tablet, device 102(5) is manifest as a smart phone, and device 102(6) is manifest as a flexible or foldable device, such as an e-reader, tablet, or phone that can be flexed into different physical configurations, such as opened or closed. Flexing the device can impart stress forces on individual pixels.

Individual devices can include a display 104. Devices 102 can communicate over one or more networks, such as network 204. While specific device examples are illustrated for purposes of explanation, devices can be manifest in any of a myriad of ever-evolving or yet to be developed types of devices.

Individual devices 102 can be manifest as one of two illustrated configurations 206(1) and 206(2), among others. Briefly, configuration 206(1) represents an operating system centric configuration and configuration 206(2) represents a system on a chip configuration. Configuration 206(1) is organized into one or more applications 210, operating system 212, and hardware 214. Configuration 206(2) is organized into shared resources 216, dedicated resources 218, and an interface 220 there between.

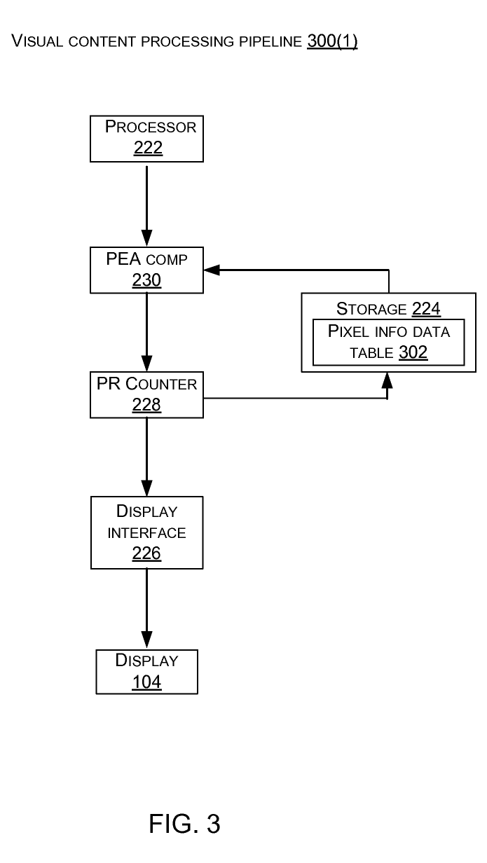

In either configuration, the devices 102 can include a processor 222, storage 224, a display interface 226, a pixel run-time (PR) counter 228, and/or a pixel effective age (PEA) compensation component 230. The function of these elements is described in more detail below relative to FIG. 3. Individual devices can alternatively or additionally include other elements, such as input/output devices, buses, etc., which are not illustrated or discussed here.

Devices 102(1) and 102(2) can be thought of as operating cooperatively to perform the present concepts. For instance, device 102(2) may include an instance of processor 222, storage 224, display interface 226, pixel run-time counter 228, and pixel effective age (PEA) compensation component 230. The device 102(2) can receive content data and process the content data into frame renderings that compensate for effective aging of individual diodes on the display of device 102(1). Device 102(2) can send adjusted frame renderings to device 102(1) for presentation on display 104(1). In contrast, devices 102(3)-102(6) may be self-contained devices that include both an instance of the display 104 and an instance of processor 222, storage 224, display interface 226, pixel run-time counter 228, and pixel effective age (PEA) compensation component 230. Thus, in this implementation, device 102(2) can implement the present concepts and send the adjusted frames to device 102(1) for presentation. As such, device 102(1) can be a legacy (e.g., pre-existing device) that when coupled to device 102(2) can offer enhanced performance (e.g. closer to original) as device 102(1) ages from use.

In an alternative implementation, a device such as device 102(3) could include a SOC configuration, such as an application specific integrated circuit (ASIC) that includes the pixel run-time counter (component) 228 and pixel effective age compensation component 230. Such a device can maintain a high level of performance even as it ages from use. Other device implementations, such as tablet device 102(4), can include a processor 222, such as CPU and/or GPU, that renders frames and can also execute the pixel run-time counter 228 and pixel effective age compensation component 230 on the same processor or on another processor.

From one perspective, any of devices 102 can be viewed as computers. The term “device,” “computer,” or “computing device” as used herein can mean any type of device that has some amount of processing capability and/or storage capability. Processing capability can be provided by one or more processors that can execute data in the form of computer-readable instructions (e.g., computer-executable instructions) to provide a functionality. Data, such as computer-readable instructions and/or user-related data, can be stored on storage, such as storage that can be internal or external to the computer. The storage can include any one or more of volatile or non-volatile memory, hard drives, flash storage devices, and/or optical storage devices (e.g., CDs, DVDs etc.), remote storage (e.g., cloud-based storage), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and/or flash memory, among others.

In one operating system centric configuration 206(1), the pixel run-time counter 228(1) can be embedded in an application 210 and/or the operating system 212 to record sub-pixel level run-time. The pixel effective age compensation component 230 can be similarly situated to receive information from the pixel run time counter, and utilize the information to adjust frame renderings for delivery to the display interface 226(1).

As mentioned above, configuration 206(2) can be viewed as a system on a chip (SOC) type design. In such a case, functionality provided by the device can be integrated on a single SOC or multiple coupled SOCs. One or more processors 222(2) can be configured to coordinate with shared resources 216, such as memory, storage 224(2), etc., and/or one or more dedicated resources 218, such as hardware blocks configured to perform certain specific functionality. Thus, the term “processor” as used herein can also refer to central processing units (CPUs), graphical processing units (CPUs), controllers, microcontrollers, processor cores, or other types of processing devices. The pixel run-time counter 228(2) and pixel effective age compensation component 230(2) can be manifest as dedicated resources 218 and/or as shared resources 216.

One example SOC implementation can be manifest as an application specific integrated circuit (ASIC). The ASIC can include the pixel run-time counter 228(2) and/or pixel effective age compensation component 230(2). For example, the ASIC can include logic gates and memory or may be a microprocessor executing instructions to accomplish the functionality associated with the pixel run-time counter 228(2) and/or pixel effective age compensation component 230(2), such as the functionality described below relative to FIGS. 3 and/or 4. For instance, the ASIC can be configured to convert image data into frame renderings for multiple pixels. The ASIC can alternatively or additionally be configured to receive a frame rendering and to generate an adjusted frame rendering that compensates for luminance degradation of individual pixels based at least upon the stored pixel information. In one implementation, the ASIC may be manifest in a monitor type device, such as device 102(3) that does not include another processor. In another implementation, the ASIC may be associated with a display in a device that also includes a CPU and/or GPU. For instance, in a device such as tablet device 102(4), the ASIC may be associated with display 104(4) and may receive frame renderings from the device's CPU/GPU and then adjust the frame renderings to compensate for luminance degradation.

Generally, any of the functions described herein can be implemented using software, firmware, hardware (e.g., fixed-logic circuitry), or a combination of these implementations. The term “component” as used herein generally represents software, firmware, hardware, circuitry, whole devices or networks, or a combination thereof. In the case of a software implementation, for instance, these may represent program code that performs specified tasks when executed on a processor (e.g., CPU or CPUs). The program code can be stored in one or more computer-readable memory devices, such as computer-readable storage media. The features and techniques of the component are platform-independent, meaning that they may be implemented on a variety of commercial computing platforms having a variety of processing configurations.

FIG. 3 shows an example visual content (e.g., image) processing pipeline 300(1) employing elements introduced relative to FIG. 2. In the visual content pipeline, processor 222 can operate on visual content, such as static and/or video content. The processor can render a frame to ultimately be presented on the display 104 as a GUI. The pixel effective age compensation component 230 can receive the frame rendering from the processor. Assume for purposes of explanation that the display 104 is new and this is the first frame rendering. As such, the pixel effective age compensation component 230 does not perform any adjustment to the frame rendering. The visual content processing pipeline 300(1) can be customized to an individual display model, because the properties of the hardware (e.g., the LEDs) may differ between models and/or manufacturers.

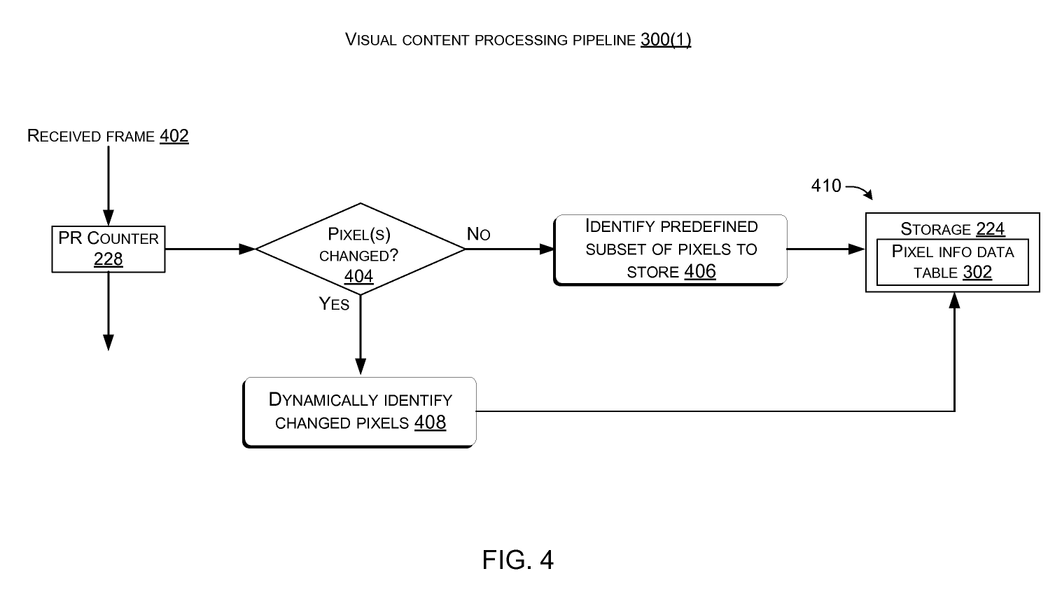

The pixel run-time counter 228 can receive the frame rendering from the pixel effective age compensation component 230 and determine whether to store information about the pixels on storage 224. This aspect is described in more detail below relative to FIGS. 4-7.

For example, the pixel run-time counter 228 saves pixel information about some or all the pixels of this frame. The pixel information can relate to individual LEDs relative to individual frames. For instance, the information can relate to the intensity that each LED was driven at in the frame rendering. The pixel information can be stored in a pixel information data table 302 in the storage 224. The pixel run-time counter 228 can supply the frame rendering to the display interface 226 to drive the display pixels to present the frame on the display 104.

Now, in these examples, the pixel effective age compensation component 230 receives another frame rendering from the processor 222. The pixel effective age compensation component can access the pixel information in the pixel information data table 302 and simulate or predict the operational age of individual pixels (e.g., their LEDs). The pixel effective age compensation component can use this operational age prediction to adjust the second frame rendering so that when presented on the display, the second frame more closely matches the appearance of the second frame as if it were presented on the display in brand new condition. The pixel effective age compensation component can then replace the second frame with the adjusted frame.

Recall that in some instances, the adjustment can entail increasing the intensity of individual LEDs to restore their luminosity output to original levels (e.g., brand new condition). However, as mentioned above, in some instances this remedy is not available. For instance, if the LEDs are already being driven at their maximum intensity (e.g., 100%) then they cannot be driven at a higher intensity and other solutions can be utilized. Some of these solutions can involve ‘dimming.’ Dimming can be thought of as lowering the intensity that relatively highly performing (e.g., relatively young operational age) LEDs are driven at so that their output can be matched by the lower performing LEDs. Variations on dimming are described below.

In this implementation, once the frame adjustment process is underway and frames are being adjusted by the pixel effective age compensation component 230, each successive frame is adjusted based upon the stored pixel information, and some subset of these adjusted frames or portions thereof can be stored by the pixel run-time counter 228.

The pixel run-time counter 228 can receive the adjusted second frame rendering and determine whether to store the pixel information for some or all of the pixels. In this configuration, the pixel run-time counter 228 can store the pixel information of the adjusted second frame rendering rather than the original second frame rendering. Thus, the stored pixel information can convey the actual intensity that the LEDs are driven at rather than the values defined in the original second frame rendering. As such, the stored pixel information can provide a more accurate representation of the operational life or age of the LEDs. The pixel run-time counter can supply the adjusted second frame rendering to the display interface 226 to create the corresponding GUI on the display.

FIG. 4 shows an example portion of visual content processing pipeline 300(1) relating to the pixel run-time counter 228. As mentioned above, the pixel run-time counter can determine whether to store pixel information from a received frame (or frame rendering) 402. Generally speaking, the pixel run-time counter can employ various techniques to determine whether to store pixel information from the received frame. Two types of these techniques can be referred to as ‘predefined’ techniques and ‘dynamic’ techniques.

Relative to the visual processing pipeline 300(1), the pixel run-time counter 228 can operate on the received frame 402 (e.g. frame rendering). In some implementations, the pixel run-time counter can consider at 404 whether any pixel or pixels are changed from the previous frame. In an instance where no pixels are changed, the pixel run-time counter 228 can at 406 identify a predefined subset of pixels from the received frame rendering to store. Stated another way, the pixel run-time counter can utilize defined techniques to identify pixels (e.g., pixel information) to store in the pixel information data table 302. Alternatively, if no pixel values have changed, the pixel run-time counter may determine not to store any pixel values in the pixel information data table 302 for the received frame.

In an instance where one or more pixels are changed relative to the previous frame, the pixel run-time counter can at 408 dynamically identify changed pixels (or a subset thereof) to store in the pixel information data table 302. As indicated generally at 410, the pixel run-time counter can store either the predefined subset of pixels or a different subset of changed pixels in the pixel information data table 302.

In relation to the predefined subset of pixels mentioned at 406, the pixel run-time counter can determine whether to store information about the pixels based upon predefined parameters. For example, in some configurations, the pixel run-time counter 228 can store all pixel information about each frame rendering. In another instance, the pixel run-time counter can store pixel information based upon predefined intervals, such as every 100^{th} frame. In such a case, the pixel run-time counter can determine if the received frame is the 100^{th} frame received since the last pixel information was stored, and if so store the pixel information from the received frame. Other defined intervals could be one frame every second or every three seconds, for example. Alternatively, the interval could be based upon a number of frames. For instance, the interval could be 50 frames or 100 frames, for example.

Further, the interval can be constant for the life of the display or can change during the life of the display. For example, the interval could be 50 frames for the first 500 hours of use of the display, 100 frames between 500 hours and 1000 hours, and 200 frames thereafter. For instance, in some implementations, intervals can be selected based upon the rate of luminosity change of the display and/or based upon other factors. For instance, another factor could be a rate of change in the frames (e.g., more static content results in greater intervals).

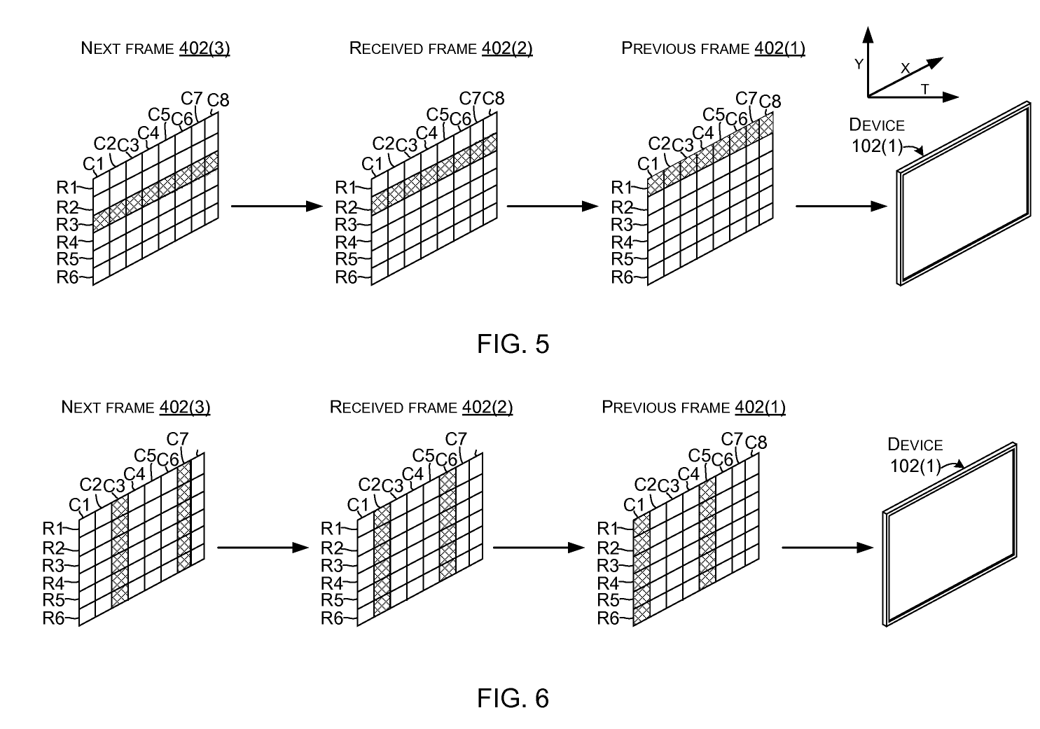

However, regardless of the interval, in some device configurations storing information about all pixels in an individual frame rendering can temporarily boost resource usage, such as processor usage, above desired levels. In contrast, some techniques that can be employed by the pixel run-time counter store information about only a subset of pixels of the received frame. Two such examples are described below relative to FIGS. 5 and 6.

FIGS. 5 and 6 show examples of two predefined sub-sets of pixels that can be stored from individual frames 402 for presentation on device 102(1). In these examples, the frames 402 include previous frame 402(1), present frame (e.g., received frame) 402(2), and next frame 402(3). In this example, for ease of illustration, the frames are manifest as 48 pixels (e.g., six horizontal rows (R) and eight vertical columns (C)). To avoid clutter on the drawing page, the content of the frames is not shown in these examples. In the case of FIG. 5, the static technique can store successive rows of pixel information indicated by cross-hatching. Thus, relative to the previous frame 402(1), the technique can store the first row (R1). Relative to the received frame 402(2), the technique can store the second row (R2), and the third row (R3) can be stored from the next frame 402(3). Thus, a full frame would be captured by combining rows from six consecutive frames and then the technique can be repeated. Of course, while 48 pixel frames are illustrated, these concepts can be applied to other frame resolutions, such as 1080×1920 pixels, 2160×4096, 2160×3840, and/or 4320×7680 pixels, among others. Further, while a single row is stored per frame in this example, other implementations could store a portion of a row or multiple rows from each frame.

FIG. 6 shows an alternative configuration where columns of pixels are stored from individual frames 402. In this case, columns 1 and 5 (C1 and C5) are stored from previous frame 402(1), columns 2 and 6 (C1 and C6) are stored from received frame 402(2), and columns 3 and 7 (C3 and C7) are stored from the next frame 402(3). Though not shown, columns 4 and 8 (C4 and C8) could be stored from the frame following the next frame to cover all pixels of a whole frame and then the technique can be repeated. Further, the number of columns skipped between frames can be selected to obtain a desired frame capture rate. For instance, in an example employing 240 columns of pixels on the display and a 60 Hertz refresh rate is employed on device 102(1), and a frame capture is desired every second, the technique could capture columns 0, 60, 120, 180, etc. of a first frame and columns 1, 61, 121, 181, etc. of the second frame and so forth so that a complete frame is captured every 60 cycles. Storing subsets of pixels per frame such as illustrated in FIGS. 5 and 6 can smooth resource usage and reduce peaks in resource usage associated with storing all pixels from a single frame.

The number of pixels stored per frame can be the same for the life of the display. For example, as mentioned above relative to FIG. 5, one row of pixels could be stored per frame for the life of the display. Alternatively, the number of pixels stored per frame can change during the life of the display. For instance, assume that the LEDs of a particular display degrade rather rapidly for the first one thousand hours of operation and then degrade relatively slowly thereafter for a remainder of the life of the display. In such a case, two rows of pixels can be stored per frame for the first one thousand hours and then one row of pixels can be stored per frame thereafter. Such a configuration can achieve a dynamic balance between the potential benefit of accurately recording pixel activity versus the resources utilized to process and store this pixel information.

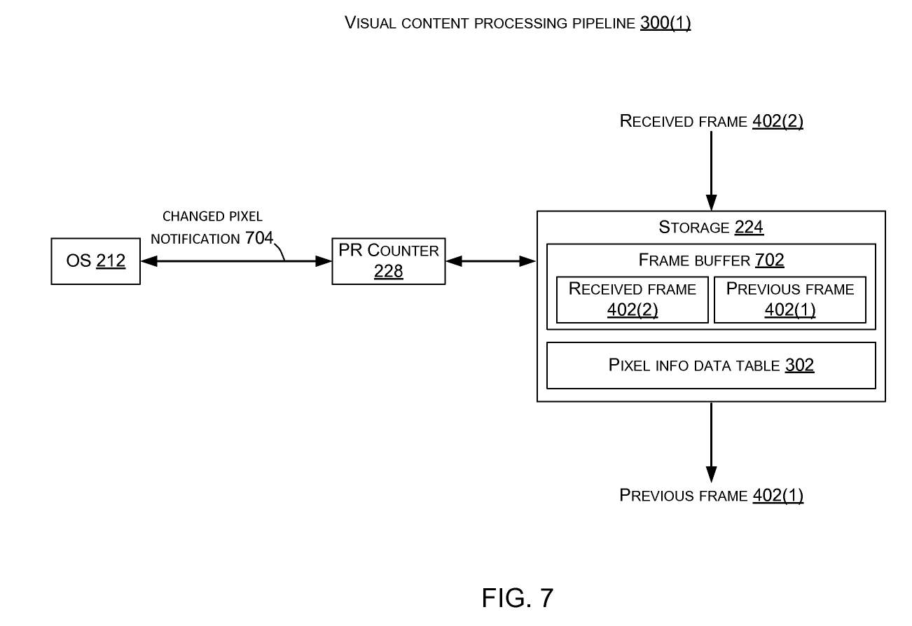

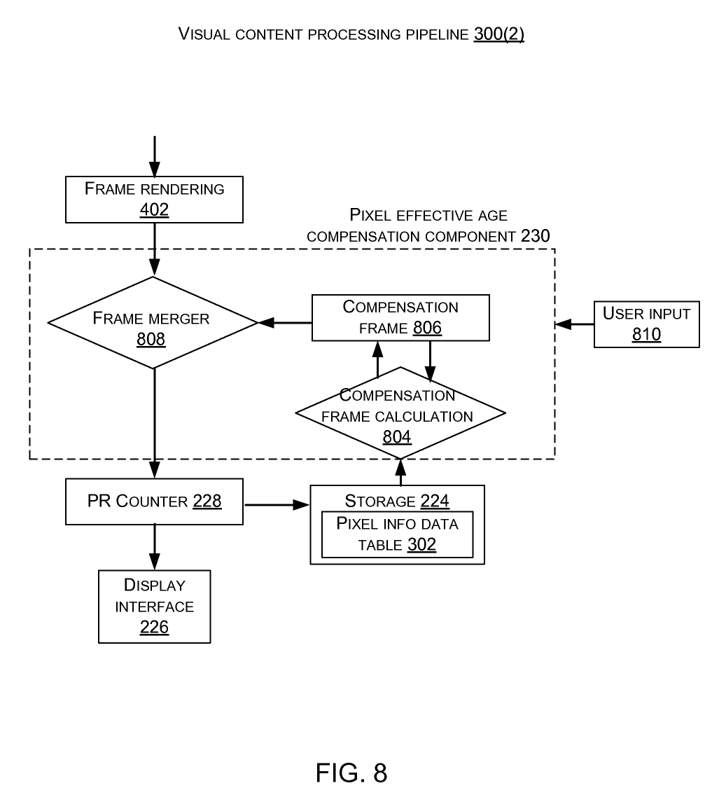

FIG. 7 shows two examples for dynamically identifying changed pixels as introduced at 408 of FIG. 4. In this case, the received frame 402(2) can be stored in a frame buffer 702. For example, the frame buffer can be part of the memory/storage 224. In this case, the frame buffer 702 can cache the received frame 402(2) and the previous frame 402(1). Other buffers may hold more frames, but the same concepts can be applied. In this case, the pixel run-time counter 228 can access the frame buffer 702 and compare the received frame 402(2) and the previous frame 402(1), such as while the previous frame is being displayed. In a case where the frames are identical, the pixel run-time counter 228 may not store any pixel information from the received frame in the pixel information data table 302 or may store a predefined subset of pixels, such as was described above relative to FIGS. 5 and 6. In a case where the received frame 402(2) has one or more pixel values that are different from the previous frame, the pixel run-time counter 228 may store pixel information for a subset of pixels that includes the changed pixels.

In an alternative configuration, the pixel run-time counter 228 may be alerted that some pixel values have changed by a changed pixel notification (e.g., dirty pixel notice) 704 (or similar notice) from the operating system 212. The changed pixel notification may indicate which pixels are affected. The pixel run-time counter 228 can use this information to determine which pixels (e.g. pixel information) to store. If the changed pixel notification does not provide sufficient detail about the changed pixels, the pixel run-time counter 228 can compare the received frame 402(2) to the previous frame 402(1) as described above to identify the changed pixels. This implementation may reduce resource usage relative to static content presentations and only save new frame information to the pixel information data table 302 when the display content actually changes.

FIG. 8 shows an alternative visual content processing pipeline 300(2). In the illustrated configuration, a frame rendering (e.g., frame 402) can be received by the pixel run-time counter 228, which can store pixel information about the frame in the pixel information data table 302. The pixel effective age compensation component 230 can use the pixel information to perform a compensation frame calculation 804 to generate a compensation frame 806. The pixel effective age compensation component can then merge the compensation frame 806 with the frame rendering 402 (e.g., frame merger 808).

In some implementations, the pixel effective age compensation component 230 may receive user input 810 relating to display preferences. For instance, the user may weight image brightness higher than color accuracy, or vice versa. Further, the user may have different preferences in different scenarios. For instance, in a bright sunlit outside scenario, the user may weight display brightness as the most important so the user can see the image despite the bright sunlight. In another scenario, such as in a home or office scenario, the user may value color quality higher than overall brightness. An optional ambient light detector may be employed on a device to detect the ambient light intensity used to discover a particular scenario. The pixel effective age compensation component 230 can utilize this user input 810 when calculating intensity values for the compensation frame 806. In one such case, the pixel effective age compensation component can utilize the user input as a factor for selecting which compensation algorithm to employ. Several compensation algorithm examples are described below and briefly, some are more effective at addressing overall brightness and some are more effective at addressing color accuracy. Further, in some implementations, the user input 810 may include user feedback. For instance, the pixel effective age compensation component 230 may select an individual compensation (with or without initial user input). The user can then look at the resultant images and provide feedback regarding whether the user likes or dislikes the image, whether the colors look accurate, etc. The pixel effective age compensation component can then readjust the compensation frame calculation 804 to attempt to address the user feedback.

Additional details of one example of the operation flow of the pixel run-time counter 228 are described below. In this implementation, the pixel run-time counter 228 can receive an individual frame and associated pixel information, such as LED intensity values and display dimming level settings. In some implementations, the pixel run-time counter 228 can record the full frame (or a subset thereof) RGB values and dimming level at the defined sampling rate. Once the frame's pixel information is recorded, the pixel run-time counter can calculate the run-time increment for individual sub-pixels based on the recorded data. As mentioned, stored information about the display's pixels may be stored relative to a single frame or a set of multiple frames. Recall that FIGS. 5 and 6 show examples of the latter scenario. The values of the run-time increment will be used to update the pixel information data table 302, where the accumulated run-time data is stored.

The pixel run-time counter 228 can function to convert the time increment of each frame's RGB grey levels into effective time increments at certain grey levels, like 255 in a scenario using 8 bit sampling from 0-255. This allows the run-time data to be stored on significantly smaller memory. In general, one such algorithm can be expressed in a function shown below:

Δt_{i,j}²⁵⁵= [symbol] (G_{i,j},φ,β,T,Δt)

Here, i and j represent the coordinates of the sub-pixel. Δt²⁵⁵ is the effective time increment at a grey level of 255, whereas Δt is the actual time increment at a grey level of G_{i,j}. T is the operational temperature of the display, β is the luminance acceleration factor, and φ is the dimming level. The function can convert the time increment at any grey level of G_{i,j} in the range of [0, 254] to the effective time increment at 255. The explicit formula of the function strongly depends on the LED lifetime characteristic employed in the display and may be adapted to different forms.

Due to the different aging characteristics of the R, G, and B LED sub-pixels, the luminance acceleration factor β can be different for R, G, B such that three individual functions can be applied to each color.

Δt_{i,j}^{R255}= [symbol] _{R}(G_{i,j}^{R},φ,β_{R},T,Δt)

Δt_{i,j}^{G255}= [symbol] _{G}(G_{i,j}^{G},φ,β_{G},T,Δt)

Δt_{i,j}^{B255}= [symbol] _{B}(G_{i,j}^{B},φ,β_{B},T,Δt)

### Accumulated Run Time Generation Example

With a sampling rate of 1 sample/sec, the pixel run-time counter 228 can record one sub-pixel grey level of 50 with actual time incremental of Δt₅₀=1 sec. A function shown below will convert that to the effective time increment of Δt₂₅₅=0.045 sec. A luminance acceleration factor of 1.9 is used here. Other functions may be used in other scenarios.

$$Δ {t}_{255} = {( \frac{50}{255} )}^{1.9} Δ {t}_{50}$$

The accumulated run-time data recorded by the pixel run-time counter 228 can be used to calculate the compensation frame 806 which will be used to compensate the image sticking and/or LED aging on the LED display. During the compensation process, the algorithm can merge the frame output from the processor with the compensation frame to greatly reduce the visibility of image sticking on the display.

Implementations that calculate operational age of individual run times are described in great detail above. An alternative implementation can measure degradation of a device directly, and then use that measurement to inform the content compensation. For example, LCD displays can be run through a temperature cycle to release mechanical stresses that may be built up due to various bonding and assembling steps during manufacture. Once these mechanical stresses are released, the LCD display may show some distortion due to this release. Some implementations can utilize a sensor, e.g., a camera, to measure the distortion and save the measurements in the device. These measurements would be static (as opposed to the continuous on-time measurements for the OLED case), and the measurements would be used just the same as the above-example to adjust the image content to compensate for the LCD display degradation.

Returning to the processing pipeline 300(2) of FIG. 8, the pixel effective age compensation component 230 can fetch the stored pixel information from the pixel information data table 302. The pixel effective age compensation component can calculate the compensation frame 806 based on the predictable degradation characteristics of the LED. Once the compensation frame is obtained, a compensation frame buffer can be updated. In the visual content processing pipeline 300(2), the frame rendering 402 from the processor can be fed to the pixel effective age compensation component 230 for the frame merger 808, in which the input frame (e.g., frame rendering 402) is merged with the compensation frame 806 stored in the buffer (702 of FIG. 7). The algorithms used in the frame merger can vary depending upon a specified or desired level of intended compensation. The output of the merger can be supplied to the pixel run-time counter 228 and ultimately to the display interface 226.

Three examples utilizing different algorithms to produce compensation are described below.

The first example can produce partial compensation with maximum brightness. In this compensation method, the algorithm intends to maximally retain the brightness of the image by accepting a limited amount of image sticking presence on the display. Assuming a frame rendering 402 with four pixels at values of X1=0.9, X2=0.8, X3=0.5 and X4=0.6, as well as a compensation frame 806 with corresponding pixel values of C1=0.8, C2=0.9, C3=0.7 and C4=0.7, the output pixel values can be calculated as:

Y1=X1/C1=1.125→1

Y2=X2/C2=0.889

Y3=X3/C3=0.714

Y4=X4/C4=0.857

Here, X1/C1 results in a value larger than one. Since the display interface 226 only accepts values in the range of [0,1], Y1 can be truncated to 1. The final input frame will be Y1=1, Y2=0.889, Y3=0.714, and Y4=0.857. It can be seen that while pixels Y2, Y3, Y4 can be completely compensated for the image sticking, pixel Y1 is under-compensated due to the limit of display driving capability. As a result, image sticking may still be visible in Y1, but in a diminished amount. Also, this algorithm can maximally keep the image brightness to the original state shown on the pristine LED display, i.e., before any aging of the LED materials.

The second example can provide complete compensation with brightness loss. In this compensation method, the algorithm intends to provide complete compensation of the image sticking by scarifying the display brightness. Assuming a frame rendering 402 with four pixels at values of X1=0.9, X2=0.8, X3=0.5 and X4=0.6, as well as compensation frame 806 with corresponding pixel values of C1=0.8, C2=0.9, C3=0.7 and C4=0.7, the output pixel values can be calculated as

T1=X1/C1=1.125

T2=X2/C2=0.889

T3=X3/C3=0.714

T4=X4/C4=0.857

Y1=T1/Max(T1,T2,T3,T4)=1.125/1.125=1

Y2=T2/Max(T1,T2,T3,T4)=0.889/1.125=0.790

Y3=T3/Max(T1,T2,T3,T4)=0.714/1.125=0.635

Y4=T4/Max(T1,T2,T3,T4)=0.857/1.125=0.762

Here, all the values fall in the range of [0,1] without clipping. Moreover, this can allow complete compensation of the image sticking on the display by maintaining the correct relative ratio in output values. However, the overall image brightness will be decreased due to normalization to the maximum values.

The third example can produce partial compensation with maximum brightness. In this compensation method, the algorithm can do an improved and potentially optimal compensation by balancing the image brightness and image sticking compensation, which falls in between the two extreme cases discussed above in the first and second examples. The algorithm can perform content analysis in the image to choose the optimal compensation level.

Assuming a frame rendering 402 with four pixels at values of X1=0.9, X2=0.8, X3=0.5, and X4=0.6, as well as a compensation frame 806 with corresponding pixel values of C1=0.8, C2=0.9, C3=0.7, and C4=0.7, the output pixel values can be calculated as:

Y1=(X1/C1)*α=1.125*α

Y2=(X2/C2)*α=0.889*α

Y3=(X3/C3)*α=0.714*α

Y4=(X4/C4)*α=0.857*α

Here, the scale factor α will be introduced to adjust the fully compensated output values. The scale factor α can be in the range of [0,1] based on the image content. For instance, if a histogram of the current image (frame) indicates a majority of the content falls in the low grey shade region, a scale factor of α=1 can be used to ensure correct compensation and brightness level. In another scenario, if the content falls in the high grey shade region mostly, a smaller value can be used depending on the histogram analysis.

To summarize, current LED displays suffer from image degradation due to operational aging of the light emitting materials, i.e., irreversible decrease of luminance with operation time. Moreover, the red, green, and blue emitting materials have different aging speeds. These occurrences can lead to image degradation from at least uneven brightness between pixels and/or non-uniform colors between pixels. The present implementations can monitor the display's LEDs, such as by using a built-in pixel run-time counter in the image processing pipeline. Some implementations can then make adjustments to the images based upon the condition of the LEDs to compensate for degradation. Further, the compensation can be achieved without changing the display hardware. The compensation can accommodate any LED aging characteristics with a predictable luminance drop as a function of operation time.

The above discussion can address each pixel individually (e.g., can determine what relative intensity to drive each individual LED of each individual pixel). Further, the present implementations can additionally increase the overall (e.g., global) power that is used to drive the display to increase the overall brightness. Thus, this overall increased driving power can compensate for the ‘dimming’ described above to restore the additional display intensity to closer to original (e.g., as new) levels.

### Method Examples

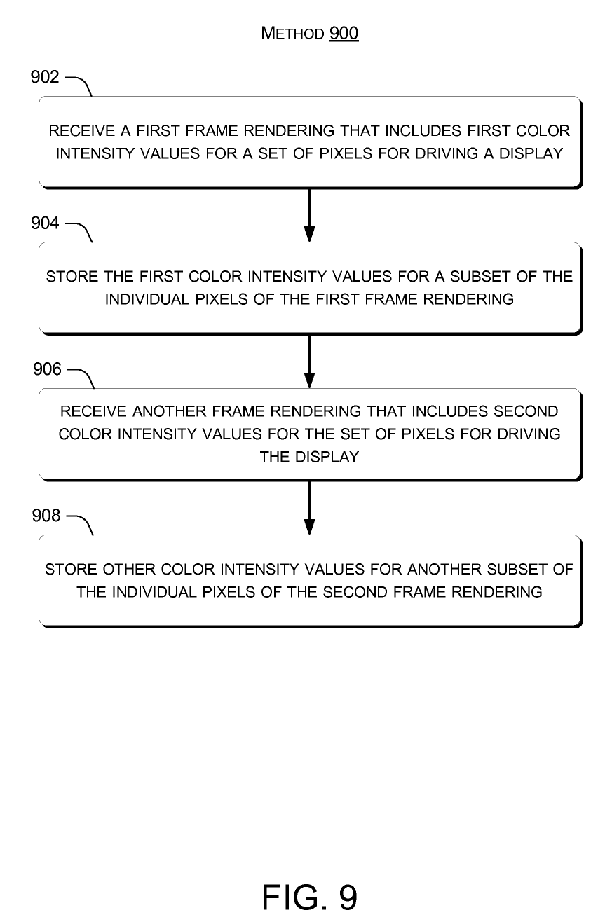

FIG. 9 shows an example method 900. In this case, block 902 can receive a first frame rendering that includes first color intensity values for a set of pixels for driving a display.

Block 904 can store the first color intensity values for a subset of the individual pixels of the first frame rendering.

Block 906 can receive another frame rendering that includes second color intensity values for the set of pixels for driving the display.

Block 908 can store other color intensity values for another subset of the individual pixels of the second frame rendering so that an illumination history of the set of pixels of the display is collectively represented by the first color intensity values for a subset of the individual pixels of the first frame rendering and the other color intensity values for the another subset of the individual pixels of the second frame rendering.

In one case, the subset can be manifest as a single pixel and the another subset can be manifest as a different single pixel. Thus, pixel information can be stored for one pixel per individual frame (e.g., per each frame rendering). In another case, the subsets can each include multiple pixels. For instance, in one case, the subsets can include individual rows of pixels. For example, in one case, the subset could include one or more rows of pixels and the another subset could include one or more subsequent rows of pixels. In another example, the subsets can be manifest as vertical columns of pixels. For example, the first subset can include one or more pixels from one or more rows of the frame. The another subset can include additional pixels that are directly vertically below the pixels of the first subset. The pixels from the rows can collectively represent columns of pixels.

Blocks 902-908 can be repeated until pixel values are stored for all pixels of the set. The process can then be repeated to store subsequent pixel values. The pixel values stored through this repeating process can be used to simulate the illumination history of the display's pixels. In some cases, the blocks can be repeated in accordance with a predefined scheme (e.g., where the subsets of pixels are predefined). Examples of such a configuration are illustrated and described above relative to FIGS. 5-6. In another configuration, storing pixel values can be triggered by changes to the image presented on the display. For example, if the image is static, a note may be stored that the image has been static for a specific duration of time (e.g., portion of the illumination history). In such a case, the previously stored values can be used for that part of the illumination history. Then, if the image changes, the changed pixel values can be saved so that the illumination history can be simulated from the values from the static period and the values from the changes.

The described methods can be performed by the systems and/or devices described above and/or by other devices and/or systems. The order in which the methods are described is not intended to be construed as a limitation, and any number of the described acts can be combined in any order to implement the method, or an alternate method. Furthermore, the method can be implemented in any suitable hardware, software, firmware, or combination thereof, such that a device can implement the method. In one case, the method is stored on computer-readable storage media as a set of instructions such that execution by a computing device causes the computing device to perform the method.

### Additional Examples

Various examples are described above. Additional examples are described below. One example is manifest as a system that can include a display comprising a set of multiple pixels. Individual pixels comprise multiple color light emitting diodes (LEDs). The system can also include a processor configured to convert image related data into frame renderings for driving the multiple pixels of the display and storage accessible by the processor. The system can also include a pixel run time counter configured to store pixel information for a subset of individual pixels relative to individual frame renderings on the storage. The stored pixel information from multiple subsets of individual pixels of the frame renderings collectively reflect time and intensity parameters that the frame renderings have driven the set of pixels. The system can further include a pixel effective age compensation component configured to receive a next frame rendering and to generate an adjusted frame rendering that compensates for luminance degradation of individual pixels based at least upon the stored pixel information for the set of pixels.

Another example can be manifest as a combination of any of the above and/or below examples where the pixel run time counter is further configured to identify whether a presently received individual frame rendering is the same or different from a directly preceding received individual frame rendering.

Another example can be manifest as a combination of any of the above and/or below examples where the pixel run time counter is further configured to identify whether the presently received individual frame rendering is the same or different from the directly preceding received individual frame rendering by comparing pixel values of the presently received individual frame rendering to the pixel values of the directly preceding received individual frame

Another example can be manifest as a combination of any of the above and/or below examples further comprising an operating system that is configured to generate the frame renderings and wherein the pixel run time counter is further configured to identify whether the presently received individual frame rendering is the same or different from the directly preceding received individual frame rendering by receiving a pixel change notification from the operating system.

Another example can be manifest as a combination of any of the above and/or below examples where the storage further comprises a frame buffer and wherein the pixel run time counter is further configured to identify whether the presently received individual frame rendering is the same or different from the directly preceding received individual frame rendering by accessing the presently received individual frame rendering and the directly preceding received individual frame rendering in the frame buffer and comparing the presently received individual frame rendering to the directly preceding received individual frame rendering.

Another example can be manifest as a combination of any of the above and/or below examples where the comparing comprises subtracting pixel values of the presently received individual frame rendering from corresponding pixel values of the directly preceding received individual frame.

Another example can be manifest as a combination of any of the above and/or below examples manifest on a single device.

Another example can be manifest as a combination of any of the above and/or below examples where the processor, the storage, the pixel run time counter and the pixel effective age compensation component are manifest as an application specific integrated circuit that is configured to drive the display.

Another example is manifest as a computer implemented process that includes receiving a first frame rendering comprising first color intensity values for a set of pixels for driving a display. The process also includes receiving another frame rendering comprising second color intensity values for the set of pixels for driving the display. The process further includes storing other color intensity values for another subset of individual pixels of the second frame rendering so that an illumination history of the set of pixels of the display is collectively represented by the first color intensity values for the subset of the individual pixels of the first frame rendering and the other color intensity values for the another subset of the individual pixels of the second frame rendering.

Another example can be manifest as a combination of any of the above and/or below examples wherein the subset comprises a single pixel and wherein the another subset comprises a different single pixel, or wherein the subset comprises a vertical column of pixels and wherein the another subset comprises another vertical column of pixels that are adjacent to the pixels of the vertical column.

Another example can be manifest as a combination of any of the above and/or below examples wherein an interval between the receiving a first frame rendering and the receiving the another frame rendering remains constant for a lifetime of the display or wherein the interval changes during the lifetime of the display.

Another example can be manifest as a combination of any of the above and/or below examples wherein the subset comprises a horizontal row of pixels and wherein the another subset comprises another horizontal row of pixels that are adjacent to the pixels of the horizontal row.

Another example can be manifest as a combination of any of the above and/or below examples wherein the receiving another frame rendering is repeated until all pixels of the set of pixels are stored, and then the process is repeated until the first or the second color intensity values are stored for all of the pixels of the set.

Another example can be manifest as a combination of any of the above and/or below examples wherein the receiving a first frame rendering, the storing the first color intensity values, the receiving another frame rendering, and the storing other color intensity values are repeated to obtain additional first and second color intensity values for pixels of the set of pixels.

Another example can be manifest as a combination of any of the above and/or below examples wherein the receiving a first frame rendering, the storing the first color intensity values, the receiving another frame rendering, and the storing other color intensity values are repeated responsive to receiving a pixel change notification.

Another example can be manifest as a combination of any of the above and/or below examples where the receiving a first frame rendering, the storing the first color intensity values, the receiving another frame rendering, and the storing other color intensity values are repeated in a predefined manner.

Another example can be manifest as a combination of any of the above and/or below examples where the process is performed for every individual frame rendering or where the process is performed on less than all of the individual frame renderings.

Another example is manifest as one or more computer-readable storage media having computer-executable instructions that, when executed by a processor of a device, cause the device to perform a method. The method comprises receiving a frame rendering for an LED display. The frame rendering comprising color intensity values for a set of pixels that are controlled by the frame rendering and identifying whether any individual color intensity values have changed for the set of pixels compared to a previous frame rendering. In an instance where no individual color intensity values have changed for the set of pixels, the method identifies a predefined subset of the pixels from the frame rendering. In an alternative instance where individual color intensity values have changed for the set of pixels, the method dynamically identifies changed pixels and stores color intensity values for a different subset of pixels that includes the changed pixels. The method also stores color intensity values from either the predefined subset of the pixels from the frame rendering or color intensity values of the different subset of the pixels.

Another example can be manifest as a combination of any of the above and/or below examples where the identifying comprises receiving an indication that color intensity values for individual pixels changed.

Another example can be manifest as a combination of any of the above and/or below examples where the identifying comprises comparing the color intensity values for the set of pixels of the frame rendering to respective color intensity values for the set of pixels of the previous frame rendering.

Another example can be manifest as a system that can include a display and storage comprising a pixel information data table. The system can include a processor configured to generate frame renderings from content. The system can further include a pixel run-time counter configured to receive a first frame rendering comprising first color intensity values for a set of pixels for driving the display and to store the first color intensity values for a subset of individual pixels of the first frame rendering in the pixel information data table. The pixel run-time counter can be configured to receive a second frame rendering comprising second color intensity values for the set of pixels for driving the display and to store other color intensity values for a second subset of individual pixels of the second frame rendering in the pixel information data table. The pixel information data table can include a stored illumination history of the set of pixels of the display.

Another example can be manifest as a combination of any of the above and/or below examples where the pixel effective age compensation component is a circuit.

Another example can be manifest as a combination of any of the above and/or below examples where the pixel run time counter is a circuit.

### CONCLUSION

Although techniques, methods, devices, systems, etc., pertaining to display diode relative age correction are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A system, comprising:
a display comprising a set of multiple pixels, and wherein individual pixels comprise multiple color light emitting diodes (LEDs);
a processor configured to convert image related data into frame renderings for driving the multiple pixels of the display;
storage accessible by the processor;
a pixel run time counter configured to store pixel information for a subset of individual pixels relative to individual frame renderings on the storage, wherein the stored pixel information from multiple subsets of individual pixels of the frame renderings collectively reflect time and intensity parameters that the frame renderings have driven the set of pixels; and,
a pixel effective age compensation component configured to receive a next frame rendering and to generate an adjusted frame rendering that compensates for luminance degradation of individual pixels based at least upon the stored pixel information for the set of pixels.

2. The system of claim 1, wherein the pixel run time counter is further configured to identify whether a presently received individual frame rendering is the same or different from a directly preceding received individual frame rendering.

3. The system of claim 2, wherein the pixel run time counter is further configured to identify whether the presently received individual frame rendering is the same or different from the directly preceding received individual frame rendering by comparing pixel values of the presently received individual frame rendering to the pixel values of the directly preceding received individual frame.

4. The system of claim 2, further comprising an operating system that is configured to generate the frame renderings and wherein the pixel run time counter is further configured to identify whether the presently received individual frame rendering is the same or different from the directly preceding received individual frame rendering by receiving a pixel change notification from the operating system.

5. The system of claim 2, wherein the storage further comprises a frame buffer and wherein the pixel run time counter is further configured to identify whether the presently received individual frame rendering is the same or different from the directly preceding received individual frame rendering by accessing the presently received individual frame rendering and the directly preceding received individual frame rendering in the frame buffer and comparing the presently received individual frame rendering to the directly preceding received individual frame rendering.

6. The system of claim 5, wherein the comparing comprises subtracting pixel values of the presently received individual frame rendering from corresponding pixel values of the directly preceding received individual frame.

7. The system of claim 1, wherein the pixel effective age compensation component is a circuit.

8. The system of claim 1, wherein the processor, the storage, the pixel run time counter and the pixel effective age compensation component are manifest as an application specific integrated circuit that is configured to drive the display.

9. A computer implemented process, comprising:
receiving a first frame rendering comprising first color intensity values for a set of pixels for driving a display;
storing the first color intensity values for a subset of individual pixels of the first frame rendering;
receiving another frame rendering comprising second color intensity values for the set of pixels for driving the display; and,
storing other color intensity values for another subset of individual pixels of the another frame rendering so that an illumination history of the set of pixels of the display is collectively represented by the first color intensity values for the subset of the individual pixels of the first frame rendering and the other color intensity values for the another subset of the individual pixels of the another frame rendering.

10. The computer implemented process of claim 9, wherein the subset comprises a single pixel and wherein the another subset comprises a different single pixel, or wherein the subset comprises a vertical column of pixels and wherein the another subset comprises another vertical column of pixels that are adjacent to the pixels of the vertical column.

11. The computer implemented process of claim 9, wherein an interval between the receiving a first frame rendering and the receiving the another frame rendering remains constant for a lifetime of the display or wherein the interval changes during the lifetime of the display.

12. The computer implemented process of claim 9, wherein the subset comprises a horizontal row of pixels and wherein the another subset comprises another horizontal row of pixels that are adjacent to the pixels of the horizontal row.

13. The computer implemented process of claim 9, wherein the receiving another frame rendering is repeated until all pixels of the set of pixels are stored, and then the process is repeated until the first or the second color intensity values are stored for all of the pixels of the set.

14. The computer implemented process of claim 13, wherein the receiving a first frame rendering, the storing the first color intensity values, the receiving another frame rendering, and the storing other color intensity values are repeated to obtain additional first and second color intensity values for pixels of the set of pixels.

15. The computer implemented process of claim 14, wherein the receiving a first frame rendering, the storing the first color intensity values, the receiving another frame rendering, and the storing other color intensity values are repeated responsive to receiving a pixel change notification.

16. The computer implemented process of claim 14, wherein the receiving a first frame rendering, the storing the first color intensity values, the receiving another frame rendering, and the storing other color intensity values are repeated in a predefined manner.

17. The computer implemented process of claim 9, wherein the process is performed for every individual frame rendering or wherein the process is performed on less than all of the individual frame renderings.

18. One or more computer-readable storage media having computer-executable instructions that, when executed by a processor of a device, cause the device to perform a method, comprising:
receiving a frame rendering for an LED display, the frame rendering comprising color intensity values for a set of pixels that are controlled by the frame rendering;
identifying whether any individual color intensity values have changed for the set of pixels compared to a previous frame rendering;
in an instance where no individual color intensity values have changed for the set of pixels, identifying a predefined subset of the pixels from the frame rendering;
in an alternative instance where individual color intensity values have changed for the set of pixels, dynamically identifying changed pixels and storing color intensity values for a different subset of pixels that includes the changed pixels; and,
storing color intensity values from either the predefined subset of the pixels from the frame rendering or color intensity values of the different subset of the pixels.

19. The computer-readable storage media of claim 18, wherein the identifying comprises receiving an indication that color intensity values for individual pixels changed.

20. The computer-readable storage media of claim 18, wherein the identifying comprises comparing the color intensity values for the set of pixels of the frame rendering to respective color intensity values for the set of pixels of the previous frame rendering.
